(19) United States
(12) Patent Application Publication
(10) Pub. No.: US 2026/0249493 A1
(43) Pub. Date: Aug. 27, 2026

(54) HANDHELD DEVICE COMPRISING A BLADE

(71) Applicant: KNIPEX-Werk C. Gustav Putsch KG, Wuppertal (DE)

(72) Inventors: Tim LIEDTKE, Wuppertal (DE); Christian HOLZ, Schwerte (DE); Rainer MESSERSCHMIDT, Düsseldorf (DE)

(73) Assignee: KNIPEX-Werk C. Gustav Putsch KG, Wuppertal (DE)

(21) Appl. No.: 19/163,471

(22) PCT Filed: Mar. 8, 2024
(86) PCT No.: PCT/EP2024/056170

§ 371 Date: Sep. 9, 2025

(30) Foreign Application Priority Data
Mar. 16, 2023 (DE) 10 2023 106 643.9

(51) Int. Cl. B26B 11/00; H02G 1/12

(52) U.S. Cl. CPC B26B 11/006; H02G 1/1214; H02G 1/1217; H02G 1/1239

(57) ABSTRACT

A handheld device has a handle part including a longitudinal extent, a first end and a second end, and a blade part including a blade. The blade part is pivotably mounted on the handle part so that the blade can be moved in a first pivoting direction out of a pivoted-in position into a first operating position. The handle part has an engagement structure, for rolling support on an item which is to be cut, The blade can be latched in the first operating position, which corresponds to a first pivoting angle, and once the latching has been disabled, free pivotability between the blade part and the handle part is made possible in a pivoting-angle range, which exceeds the first pivoting angle, so that use can be made of the engagement structure.

### TECHNICAL FIELD

The invention relates to a handheld device with a blade, wherein the handheld device has a handle part with a longitudinal extent, a first end and a second end and furthermore has a blade part with the blade, wherein the blade part, assigned to the second end, is mounted on the handle part such that it can be pivoted about a first pivot axis in a pivoting plane extending in the direction of the longitudinal extent in order to move the blade in a first pivoting direction out of a pivoted-in position, in which the second end delimits the handheld device along the longitudinal extent, into a first operating position, in which the blade protrudes beyond the second end along the longitudinal extent, and wherein the blade part can be moved back into the pivoted-in position in a second pivoting direction and the handle part has on the second end an engagement structure for rolling support on an object to be cut.

The invention also relates to a handheld device with a blade, wherein the handheld device has a handle part and a blade part with the blade, wherein the blade part furthermore has a longitudinal extent and is fastened on the handle part on a first end, wherein another, second free end of the blade part, which is located distant from the first end in the direction of the longitudinal extent, has a leading edge, wherein the blade furthermore has a cutting edge, and wherein the leading edge, as well as the cutting edge, ends in a sliding shoe that protrudes beyond a section of the cutting edge extending along the longitudinal extent of the blade part.

The invention furthermore relates to a handheld device with a blade, wherein the handheld device has a handle part and a blade part with the blade, wherein the blade part furthermore has a longitudinal extent and is fastened on the handle part on a first end, wherein another, second free end of the blade part, which is located distant from the first end in the direction of the longitudinal extent, has a leading edge, and wherein the blade furthermore has a cutting edge and the blade part has a blade protection part that covers a rear edge of the blade facing away from the cutting edge.

### PRIOR ART

Handheld devices of the type in question are known in different designs. They serve, for example, as so-called cable stripping knives for removing a sheath from electric cables. Furthermore, handheld devices of this type can also be used for other cutting tasks. In this context, reference is made, for example, to EP 0 610 841 B1.

Furthermore, a handheld device in the form of a cable stripping knife is also known, for example, from DE 10 2004 005 646 B4, wherein this handheld device has a pivotable blade protection part that, when the handheld device is not in use, completely covers the blade in the region of the rear edge, the leading edge, as well as the two broad surfaces connecting the rear edge to the cutting edge, and freely extends beyond the cutting edge. In order to use the handheld device, the blade protection part needs to be pivoted into a position that exposes the cutting edge, wherein the blade protection part is in this exposed position spaced apart from the rear edge and also exposes the leading edge and portions of the broad surfaces of the blade.

### SUMMARY OF THE INVENTION

In light of the above-describe the prior art, the invention is based on the objective of advantageously enhancing a handheld device of the type in question with respect to favorable handling.

According to a first inventive idea, this objective is potentially attained with a handheld device, in which it is proposed that the blade can be latched in the first operating position, which corresponds to a first pivoting angle, and that, once the latching has been disabled, free pivotability between the blade part and the handle part is made possible in a pivoting angle range exceeding the first pivoting angle in order to make use of the engagement structure.

Starting from the pivoted-in position, which also may be a protected position of non-use for the blade, the blade part can be pivoted into a position beyond the first operating position in the direction the first pivoting direction. The blade part preferably is not latched in this second operating position and therefore is freely pivotable about the pivot axis between the first operating position and a preferably stop-limited pivoting end position. For example, this may result in a free pivoting angle range of approximately 60 to 120°, e.g. approximately 80 to 100°.

It is furthermore preferred that the first, latched operating position is not reached in the course of the free pivotability of the blade part during a conventional cutting process, which is carried out by using the engagement structure on the side of the handle part and the toggle lever-like effect on the blade part, particularly on the blade.

The engagement structure formed on the side of the handle part interacts with the object to be cut, particularly with the facing surface of the object, when the handheld device is in use, particularly in the course of using the handheld device under rolling support on the object in the form of a temporary abutment. As a result of an alternating pivoting movement of the blade part, the blade attached to an object to be cut such as a sheath of an electrical cable can be moved relative to the handle part in the first and in the second pivoting direction in a ratchet-like manner within the resulting pivoting angle range by using the engagement structure on the side of the handle part, particularly in the direction of an longitudinal extent of the object to be cut, but alternatively also, for example, during a circumferential cut, particularly on objects with a large diameter. Such an application of the handheld device advantageously results in a toggle lever-like interaction between the handle part and the blade part, wherein this interaction particularly, but not exclusively, proves advantageous in terms of handling during a pulling displacement of the blade through the object to be cut. In this way, a force-saving transmission ratio is achieved in the course of the cutting process. The blade edge is pulled through the object to be cut, for example, like a plow in this case.

Furthermore, a conventional cut can also be produced by means of the proposed handheld device in the latch-secured first operating position of the blade part. In this first operating position, the handheld device can be used like a normal knife with a rigid blade part that essentially protrudes beyond the second end of the handle part in the longitudinal direction.

Consequently, the handheld device can be used in at least two independent operating positions.

The above-defined objective is potentially also attained in that the cutting edge has a cutting projection that protrudes relative to the remaining section of the cutting edge extending along the longitudinal extent of the blade part, and in that the cutting projection is formed on the end of the blade facing the handle part.

For example, a circumferential cut can be advantageously produced in terms of handling on the object to be cut, e.g. a cable sheath, by using such a cutting projection, wherein the exposed cutting projection also advantageously promotes an attachment to and an initial penetration into the material to be cut.

Furthermore, an (initial) incision in the longitudinal direction of, for example, a cable sheath can be advantageously produced at a distance from a free cable end by means of such a cutting projection. Subsequently, the sliding shoe can be guided through the slot-like incision being produced in the cable sheath, optionally while continuing the cutting process by means of a cutting edge following the sliding shoe, and the incision can then be extended as needed in the longitudinal direction of the cable. If applicable, the longitudinal cut produced during this process can be selectively achieved by pulling or pressing the handheld tool. A section of the cable sheath that is spaced apart from the free cable end can be removed after producing two additional cuts in the circumferential direction, which delimit the longitudinal cut on both sides.

This cutting projection is arranged significantly closer to the handle part than to the sliding shoe with respect to the longitudinal extent of the blade part.

If the blade part is designed in a pivotable manner, the cutting projection is formed on the end of the blade or the blade part assigned to the pivot axis.

According to another inventive idea, the above-defined objective is potentially also attained with a handheld device, in which it is proposed that, when the blade protection part is supported on the rear edge of the blade, the cutting edge is exposed and the blade protection part not only covers the rear edge, but also part of the leading edge and a transition of the leading edge into the rear edge.

Accordingly, the blade protection part is advantageously designed in terms of handling in such a way that, as a result of its preferably continuous contact with the rear edge of the blade, it can serve for supporting a finger of the user in order to thereby exert pressure upon the blade in the course of the cutting process. In this case, the blade protection part is designed in such a way that the cutting edge preferably is completely exposed for use and the leading edge is exposed for use over a section starting from the cutting edge. In order to prevent injuries in case a finger acting upon the blade protection part accidentally slips off, not only the rear edge providing the support for the finger via the blade protection part is covered by the blade protection part, but also the transition into the leading edge and a section of the leading edge following the transition. The relevant sections of the blade also remain protected in the position of use.

With respect to the cutting edge, it is proposed that this cutting edge preferably is completely exposed. In contrast, the leading edge may be covered, for example, over ¼ to ½ of its length, e.g. over ⅓ of its length, starting from the rear edge.

The characteristics of the above-described independent claims respectively are important individually, as well as in any combination with one another, wherein characteristics of an independent claim furthermore can be combined with the characteristics another independent claim or with the characteristics of several independent claims, as well as with only individual characteristics of one or more of the other independent claims.

According to a potential embodiment, the invention therefore provides a handheld device, in which the blade can be latched in the first operating position, which corresponds to a first pivoting angle, and in which, once the latching has been disabled, free pivotability between the blade part and the handle part is made possible in a pivoting angle range exceeding the first pivoting angle in order to make use of the engagement structure, wherein the cutting edge furthermore is exposed when a blade protection part is supported on the rear edge of the blade and the blade protection part not only covers the rear edge, but also part of the leading edge and a transition of the leading edge into the rear edge and/or wherein the cutting edge has a cutting projection that protrudes relative to the remaining section of the cutting edge extending along the longitudinal extent of the blade part and the cutting projection is formed on the end of the blade facing the handle part.

Other characteristics are frequently described below, as well as in the description of the figures, in their preferred association with the basically described solutions or with other characteristics. However, they may also be important in association with only individual characteristics described above or the respective characteristic described below or independently.

The engagement structure provided on the end of the handle part may be realized in the form of a profiling of the corresponding handle part section. For example, the engagement structure may be a rib structure, e.g. in the form of a toothed ledge extending in a bent manner in a plane that, in a section through the handle part, is aligned parallel to the pivot axis of the blade part. This results in a preferred rolling direction of the blade part with a corresponding geometric rolling axis extending perpendicular to the pivot axis of the blade part.

According to a preferred embodiment, the engagement structure may in the first operating position extend beyond the blade viewed in the first pivoting direction. The engagement structure accordingly may be exposed adjacent to the blade part with respect to the first pivoting direction in the region of the second end of the handle part in the first operating position.

According to another embodiment, the blade part may be pivotable into a third operating position that corresponds to a third pivoting angle, wherein the blade part can also be latched in this third operating position. This third operating position preferably can be provided between the pivoted-in position and the first operating position in the direction of the first pivoting direction. However, it would also be possible, for example, to provide the third or even additional latched operating positions between the first operating position and a stop-limited pivoting end position of the blade part in the direction of the first pivoting direction.

According to a preferred embodiment, the third pivoting angle may correspond to 1/10 to 9/10 of the first pivoting angle. A first potential pivoting angle for pivoting the blade part from the pivoted-in position into the operating position may amount, for example, to 90 to 180° or more and be as large is 210° or more, e.g. approximately 120 to 150°. Starting from the pivoted-in position, a third pivoting angle of the blade part in the third operating position accordingly may amount, for example, to approximately 75 to 120°, e.g. to approximately 80 to 100°.

The pivoted-in position of the blade the part preferably can also be latched. According to a preferred embodiment, the blade part therefore may have a total of three latchable pivoting positions, namely the pivoted-in position of non-use of the blade part, the first operating position and preferably the third operating position provided between the pivoted-in position and the first operating position in the first pivoting direction. The respective latched position preferably can be assumed automatically once the respective pivoting position of the blade part is reached and the latching preferably can only be disabled again intentionally with a purposeful intervention by the user.

The third operating position may be a securing position that prevents an undesirable and complete backward pivoting movement of the blade part into the pivoted-in position, for example, when the blade part is not property latched in the first operating position. In such a case, the blade part moves into the third operating position and is latched therein, wherein a further pivoting movement of the blade part from the third operating position is only possible by intentionally disabling the latching. The risk of injuries to one or more fingers encompassing the handle part during an uncontrolled backward pivoting movement of the blade part in the direction of the pivoted-in position is therefore averted.

The latching preferably can be produced between a handle part end of the blade part assigned to the handle part and a latching part provided in the handle part. It is furthermore preferred that the latching part is exposed in order to be actuated by a finger, e.g. the thumb of the hand of the user holding the remainder of the handheld device, in an ergonomically favorable manner. In this context, it is furthermore preferred that the latching part can be displaced between a latching position, in which the operating position of the blade part is secured, and a pivoting release position for the blade part.

The latching part may be movable, for example, perpendicular to the pivoting plane. A resulting direction of displacement of the latching part therefore is in preferred parallel alignment with the pivot axis of the blade part.

The latching part may also be spring-loaded, particularly in the direction of the latching position, by means of a spring that acts upon the latching part accordingly. For example, pressure spring such as a cylindrical pressure spring may be provided for this purpose, wherein said pressure spring is supported on the handle part with one end and acts upon the latching part with the other end. The intentional linear displacement of the latching part from the latching position into a release position is realized, for example, by exerting pressure with a finger.

In order to prevent an accidental actuation of the latching part in the direction of the pivoting release position of the blade part, it is proposed, according to an enhancement of the object of the invention, that the latching part can be blocked in a latching position by means of a first blocking part. Accordingly, an intentional displacement of the first blocking part by the user is initially required in order to disengage the latching position of the blade part. Subsequently, blocking of the latching part in the latching position is disabled. Consequently, (at least) two successive measures are required in order to disengage the latching position of the blade part.

The first blocking part may be spring-loaded in the direction of the blocking position. This may likewise be realized, for example, by providing a pressure spring such as a cylindrical pressure spring that is supported on the handle part with one end and acts against the first blocking part with the other end.

It would also be possible that the first blocking part initially has to be displaced into this position in order to assume the latching position between the blade part and the latching part on the side of the handle part, wherein this latching position is blocked after it has been assumed by displacing the first blocking part backward. However, it would in this context also be possible to realize an embodiment, in which, in the course of a pivoting movement of the blade part, the latching part is automatically displaced in the direction of the latching position in a spring-assisted manner as described above and in the process presses the first blocking part into the blocking release position against the force of the spring acting upon the first blocking part, e.g. by means of a control bevel, wherein the first blocking part automatically reassumes the blocking position as a result of the spring action once the displacement end position of the latching part is reached in the latching position.

According to a preferred embodiment, the first blocking part may be a sliding part that can be moved, preferably linearly, between a release position and a blocking position in a plane that lies parallel to the pivoting plane. Such a sliding part preferably is also arranged on the handle part in an ergonomically favorable manner such that the user can successively actuate the first blocking part and also the latching part, for example, with the thumb of the hand holding the remainder of the handheld device.

According to another potential embodiment, the sliding part or the first blocking part can be fixed in its blocking position by means of a second blocking part. The first blocking part furthermore may represent, for example, a transport or storage safety.

The second blocking part may be a flap part that is movable about a second pivot axis. This flap part preferably is also positioned in an ergonomically favorable manner and can be reached, for example, with a finger, particularly the thumb, of the hand of the user holding the remainder of the handheld device. The pivoting plane of the flap part may extend essentially perpendicular to the pivoting plane of the blade part or perpendicular to the plane of displacement of the first blocking part. In another embodiment, the pivoting plane of the flap part may essentially extend in alignment with the sliding direction of the first blocking part.

The handle part end of the blade part preferably is accommodated in the handle part. It is furthermore preferred that this accommodation of the handle part end in the handle part is realized in any possible pivoting position of the blade part.

The blade preferably can have a cutting edge and a rear edge. The rear edge preferably is not designed for acting upon objects in a cutting manner. It is therefore preferred to realize the rear edge in a blunt manner like a conventional back of a knife.

The cutting edge preferably is configured and designed for cutting, for example, a cable sheath along its longitudinal extent in a pulling manner. The blade may furthermore have a second free end that is located distant from the handle part end in a direction of the longitudinal extent and has a leading edge. In another embodiment, this leading edge preferably is realized in the form of a leading cutting edge, by means of which the blade can be moved opposite to the direction of displacement during pulling cutting while being subjected to pressure. Accordingly, the blade is designed for pulling cutting, as well as for pressing cutting-with respect to a longitudinal extent of the handle part.

According to a potential embodiment, the cutting projection may protrude relative to the section of the cutting edge located directly adjacent thereto along the longitudinal extent by a dimension that amounts to 1.5 mm or more and may, for example, be as large as 3 mm or even 5 mm. The section of the cutting edge located directly adjacent to the cutting projection in the direction of the first end preferably extends essentially linearly, if applicable, over a length that may approximately correspond to 0.5-times to 0.8-times the total length of this cutting edge. A section located directly adjacent to the linear section may extend, for example, in a curved manner as far as the optionally provided sliding shoe.

In a view in which the cutting edge is illustrated in the form of a line, the cutting projection may be realized, for example, in a pointed manner similar to a gable roof, wherein the edges of the projection that meet in the tip preferably are realized in the form of cutting edges. The tip allows an advantageous penetration into the object to be cut, e.g. the cable sheath. The formation of cutting edges on both sides furthermore promotes the cutting process, which is a result of this design can be carried out in a pulling manner, as well as in a pressing manner-viewed from the handle part or also viewed in the circumferential direction.

In a pivotable design of the blade part, the cutting projection may protrude relative to the remaining cutting edge viewed in the second pivoting direction. The cutting projection may be realized in the form of a sharp-edged design in the transition from the cutting edge into a terminal outer edge of the blade facing the handle part. This sharp-edged transition region may also be rounded or formed by a spike in the form of a sharp-edged projection that protrudes relative to the remaining cutting edge.

The above-described cutting projection and the terminal outer edge of the blade facing the handle part preferably extend at a distance from the handle part viewed in the direction of the longitudinal extent of the blade. This already makes it possible to respectively expose or lay bare the corresponding transition region of the cutting edge.

Furthermore, a part of the blade comprising the cutting edge with the cutting projection may be accommodated in a receptacle formation of the handle part in the pivoted-in position. In this context, it is furthermore preferred that the cutting edge with the cutting projection, as well as essentially also the cutting edge-like leading edge, is completely accommodated in the receptacle formation. The receptacle formation may be essentially adapted to the geometry of the blade and therefore be realized in a slot-shaped manner.

The blade may have a sliding shoe in another embodiment. The sliding shoe preferably is arranged in a beak-shaped transition region between the cutting edge and the leading edge and, in particular, primarily serves for preventing damages to the conductors that are encompassed by the cable sheath to be cut open, particularly in the longitudinal direction, in the course of stripping an electric cable. In another preferred embodiment, this cutting edge region with the sliding shoe is also completely accommodated in the receptacle formation of the handle part in the pivoted-in position.

In another embodiment, the blade protection part assigned to the rear edge of the blade may remain outside the receptacle formation in the pivoted-in position. The rear edge of the blade is also covered by the blade protection part at least over the length of the blade protection part in the pivoted-in position.

The blade protection part may be a plastic part that is fastened on the blade, e.g. an injection-molded plastic part that is snapped on the blade.

In another non-latched operating position of the blade, the blade protection part furthermore can be used for applying pressure, e.g. while producing a circumferential cut, wherein the object to be cut over the circumference furthermore may be captured, for example, between the blade part, particularly the cutting edge, and the section of the handle part having the receptacle formation.

According to a potential embodiment, the blade protection part may for this purpose have a depression in the direction of the longitudinal extent, wherein said depression serves for accommodating a supporting finger of a user. Such a depression may be realized, for example, similar to a trough and furthermore have a profiled surface in order to improve the anti-slip reliability for the finger. This depression enables the user to exert pressure upon the blade, particularly upon the cutting edge, with the finger.

A portion of the rear edge may be exposed between the handle part and the blade protection part. According to a potential embodiment, this section of the rear edge, which is not covered by the blade protection part and faces the handle part, may be formed, for example, in any operating position of the blade part, as well as in the pivoted-in position of the blade part. With respect to the first operating position of the blade part, for example, the non-covered region of the rear edge may, in a top view of the handheld device in which the pivoting plane of the blade part is illustrated in the form of a line, extend over a certain free length outside the handle part viewed along the longitudinal extent of the handle part, wherein this certain free length may correspond to approximately one-third to one-sixth, for example to approximately one-fourth to one-fifth, of the total length of the blade part outside the handle part.

According to another potential embodiment, the leading edge, which preferably is realized in the form of a cutting edge, may have a region that is exposed beyond the blade protection part and may have a length of less than 10 mm, e.g. between approximately 4 mm and approximately 6 mm. This free length of the region of the leading edge usable for cutting can be adapted, for example, to a thickness of a cable sheath.

With respect to the disclosure, the ranges or value ranges or multiple ranges indicated above and below also include all intermediate values, particularly in 1/10 increments of the respective dimension, but optionally also dimensionless. For example, the indication 1/10 to 9/10 or 0.1-times to 0.9-times also includes the disclosure of 0.2-times to 0.9-times, 0.1-times to 0.8-times, 0.2-times to 0.8-times, etc., and the disclosure of 120° to 150° also includes the disclosure of 120.1° to 150°, 120° to 149.9°, 120.1° to 149.9°, etc. The respective disclosure may on the one hand serve for defining a lower and/or upper limit of a cited range, but alternatively or additionally also for disclosing one or more singular values from a respectively indicated range.

### BRIEF DESCRIPTION OF THE DRAWINGS

The invention is described in greater detail below with reference to the attached drawings that, however, merely show exemplary embodiments. A component, which is described with reference to of the exemplary embodiments and not replaced with a different component in another exemplary embodiment, is therefore also described as a potentially existing component in this other exemplary embodiment. In the respective drawings:

FIG. 1 shows a perspective view of a first embodiment of a handheld device concerning a first operating position of a blade part;

FIG. 2 shows an exploded perspective view of the handheld device according to the first embodiment;

FIG. 3 shows the bottom view of the handheld device according to the arrow III in FIG. 1 concerning a pivoted-in position of the blade part;

FIG. 4 shows the top view of the handheld device according to the arrow IV in FIG. 1 concerning the position of the blade part in FIG. 3;

FIG. 5 shows the front view according to the arrow V in FIG. 4;

FIG. 6 shows the side view of the handheld device according to the arrow VI in FIG. 4;

FIG. 7 shows the section through the plane of section VII in FIG. 1 concerning the first operating position of the blade part, with other blade part positions illustrated with dot-dash lines;

FIG. 7a shows the enlargement of the region VIIa in FIG. 7;

FIG. 7b shows an individual illustration of the blade part in the form of a section according to FIG. 7;

FIG. 8 shows the enlargement of the region VIII and FIG. 7;

FIG. 9 shows an enlarged illustration according to FIG. 8, but concerning the pivoted-in position of the blade part;

FIG. 10 shows the handheld device in the form of a side view according to FIG. 6, but concerning the first operating position according to FIG. 1;

FIG. 11 shows the top view of the handheld device according to the arrow XI in FIG. 10;

FIG. 12 shows the front view of the handheld device according to the arrow XII in FIG. 10;

FIG. 13 shows the enlargement of the region XIII in FIG. 10;

FIG. 14 essentially shows the region of the handheld device and the blade part illustrated in FIG. 13 in the form of a perspective view;

FIG. 15 shows the handheld device with the blade part in the first operating position in the course of using the handheld device for cutting an object;

FIG. 16 shows the enlarged illustration of the region XVI in FIG. 15;

FIG. 17 shows a side view of the handheld device with the blade part in the first operating position while using a cutting projection for incising the object in the circumferential direction;

FIG. 18 shows the enlargement of the region XVIII in FIG. 17;

FIG. 19 shows a follow-up illustration to FIG. 18 concerning a situation in the course of initially incising the object with the cutting projection of the blade part;

FIG. 20 shows an illustration corresponding to FIG. 18, but concerning a second embodiment of the cutting projection;

FIG. 21 shows another illustration corresponding to FIG. 18, but concerning a third embodiment of the cutting projection;

FIG. 22 shows the handheld device in the form of a side view according to FIG. 6, but concerning a third operating position of the blade part;

FIG. 23 shows an enlarged sectional view according to FIG. 8 concerning the operating position of the blade part in FIG. 22;

FIG. 24 shows another enlarged sectional view corresponding to FIG. 8, but concerning an intermediate position between the third operating position and the pivoted-in position of the blade part;

FIG. 25 shows another side view of the handheld device corresponding to FIG. 6, but concerning the blade part in a second operating position;

FIG. 26 shows an enlarged sectional view corresponding to FIG. 8 and concerning the operating position of the blade part in FIG. 25;

FIG. 27 shows the handheld device with the blade part in the second operating position concerning the use of the handheld device in the course of producing a longitudinal cut through an object;

FIG. 28 shows a follow-up illustration to FIG. 27 during a rolling pivoting movement of a handle part of the handheld device relative to the blade part;

FIG. 29 shows a partially sectioned and partially exploded perspective view of the handheld device concerning a latching between the handle part and the blade part;

FIG. 30 shows a partially sectioned perspective view of the region of interaction between the blade part and the handle part concerning a blocked latching position of the blade part;

FIG. 31 shows the section along the plane of section XXXI in FIG. 30;

FIG. 32 shows the section along the plane of section XXXII in FIG. 30;

FIG. 33 shows an illustration corresponding to FIG. 30 concerning the position after disabling the latching between the blade part and the handle part;

FIG. 34 shows the section along the plane of section XXXIV in FIG. 33;

FIG. 35 shows the section along the plane of section XXXV in FIG. 33;

FIG. 36 shows the enlargement of the region XXXVI in FIG. 13;

FIG. 37 shows the handheld device in the form of a side view according to FIG. 10, but concerning another embodiment; and

FIG. 38 shows a side view of an additional embodiment of the handheld device.

### DESCRIPTION OF THE EMBODIMENTS

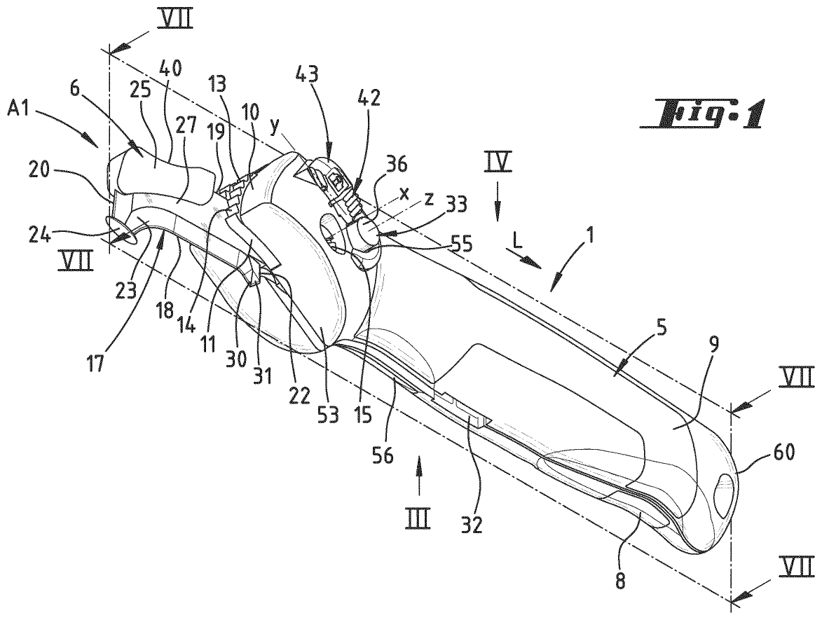

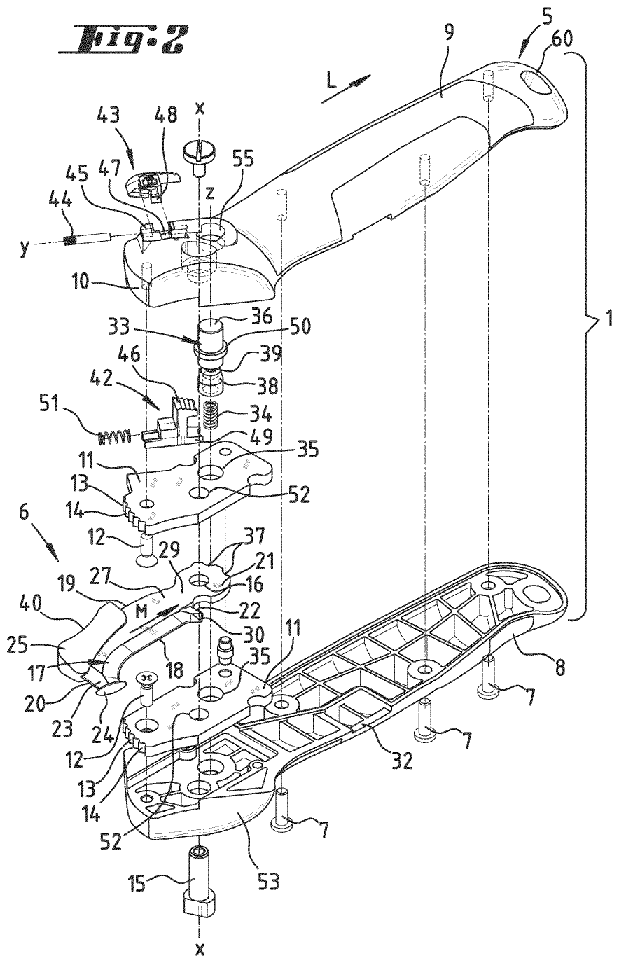

A handheld device 1 for cutting objects 2, particularly in the form of electric cables, is initially described with reference to FIGS. 1 and 2, wherein an insulating sheath 4 that surrounds and protects conductors 3 can be incised by using the handheld device 1 in order to remove said insulating sheath.

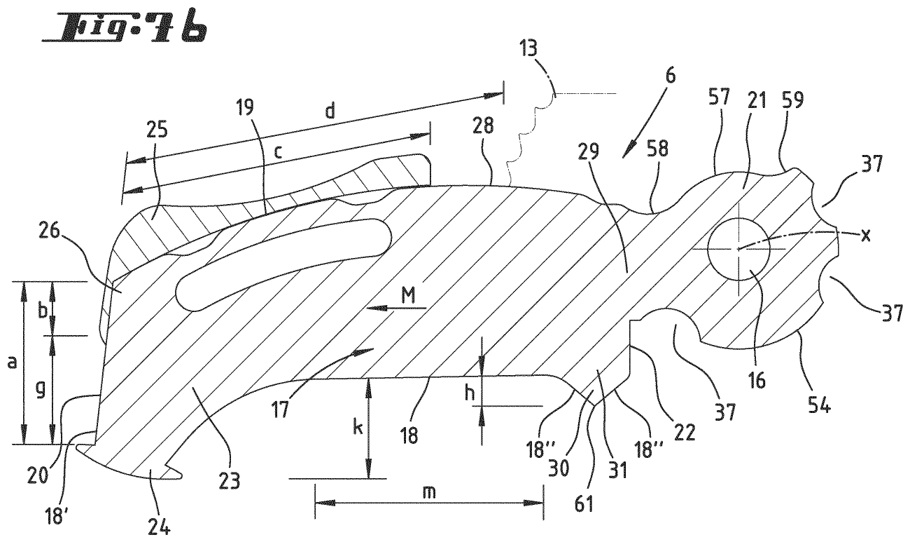

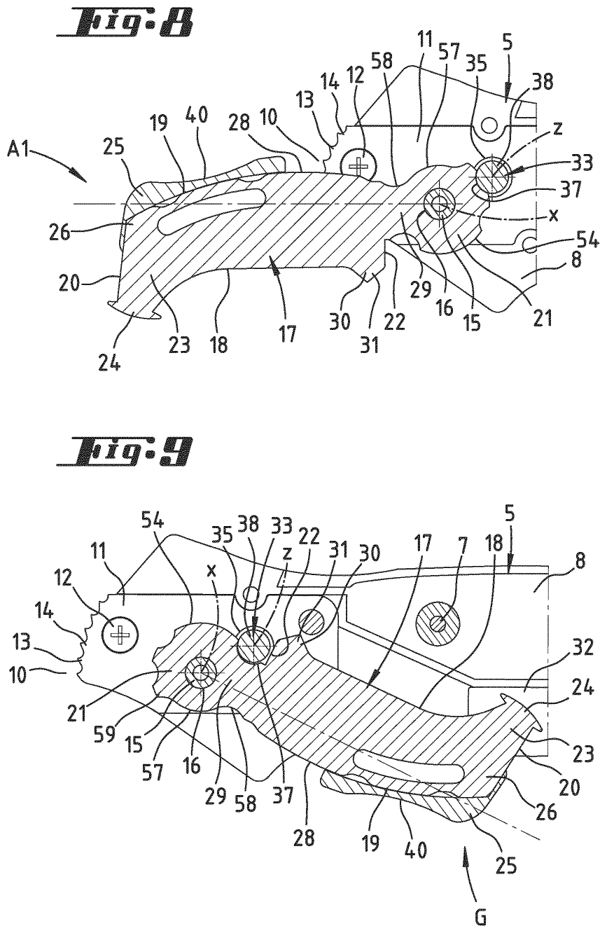

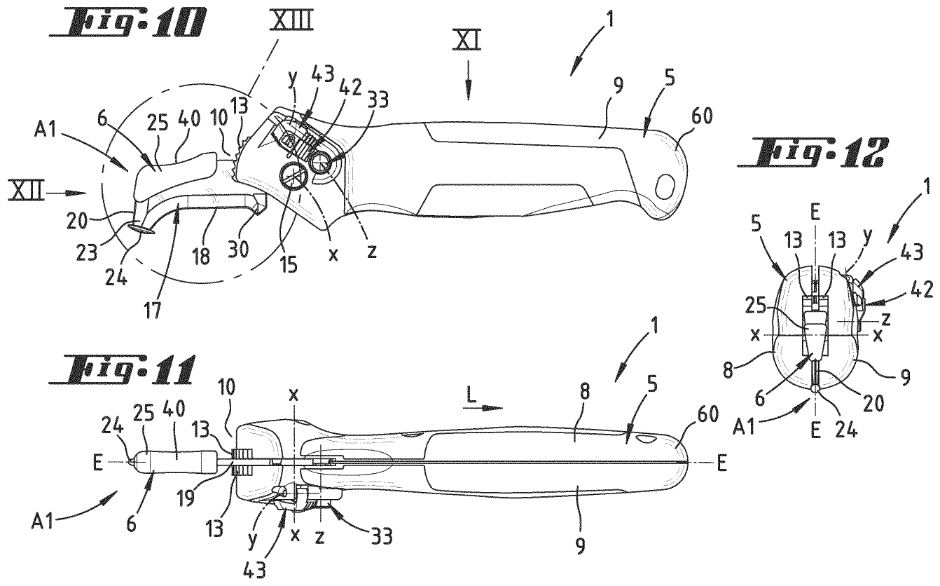

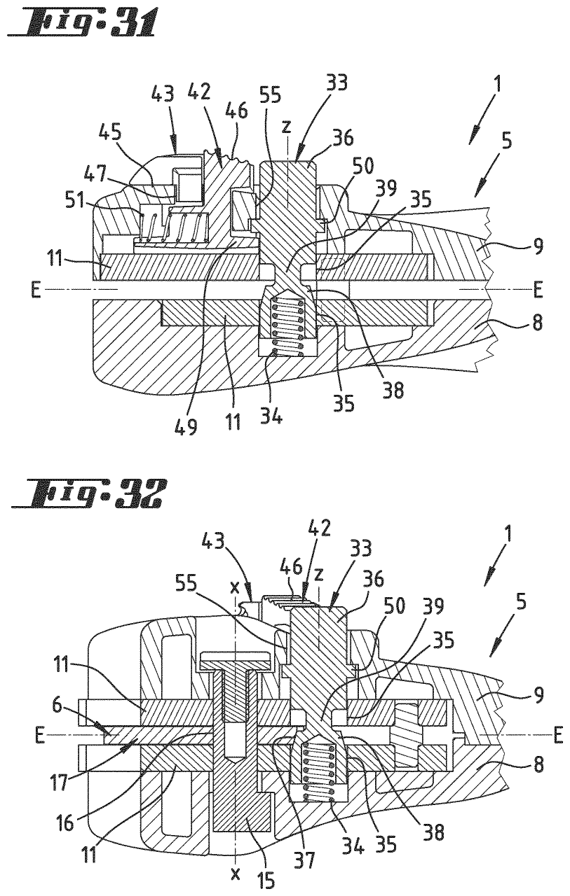

The handheld device 1 according to the embodiments illustrated in FIGS. 1 to 36 essentially is composed of a handle part 5 and a blade part 6 that is pivotably mounted on the handle part 5. The corresponding geometric pivot axis x extends transverse to a longitudinal extent L of the handle part 5.

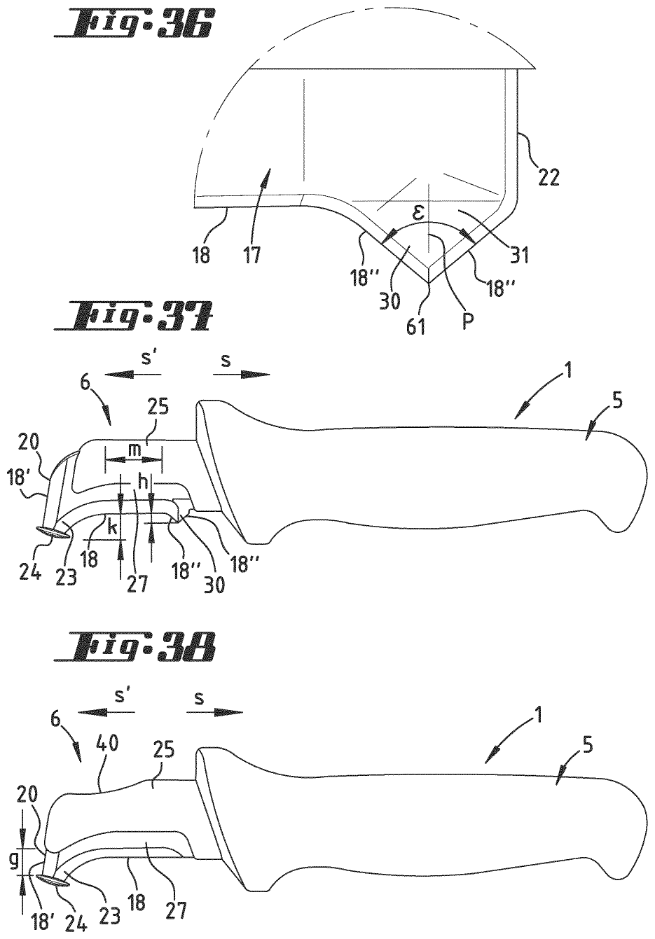

FIGS. 37 and 38 show embodiments, in which the blade part 6 is mounted on the handle part 5 rigidly, i.e. not pivotably.

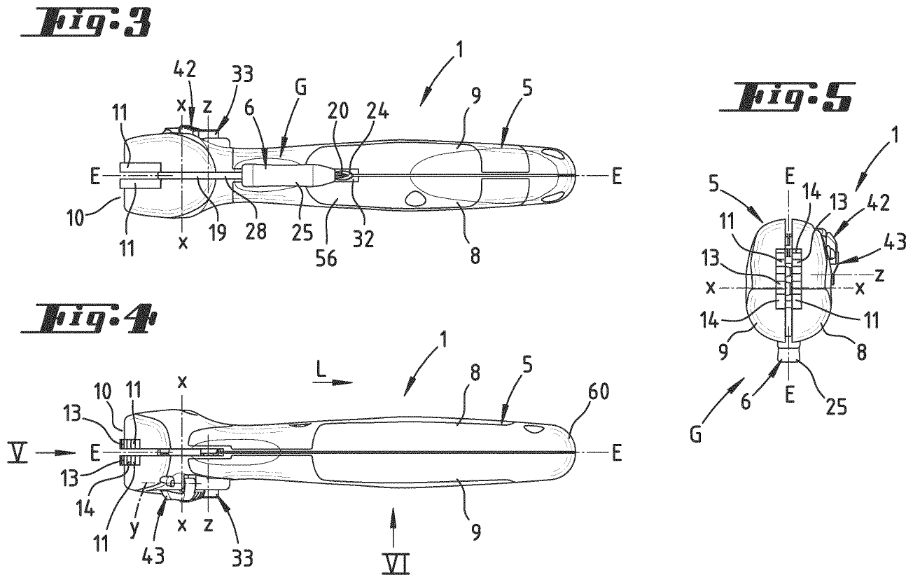

The handle part 5 preferably is composed of two handle shells 8 and 9 that can be connected to one another by means of screws 7, wherein a contact plane of the two handle shells 8 and 9 preferably can coincide with a pivoting plane E of the blade part 6 (see, for example, FIG. 4).

The handle part 5 has a free first end 60 that faces away from the blade part 6 and a second end 10 that faces the blade part 6. An insert 11 is accommodated in the respective handle shell 8, 9 in the end section of the handle part 5 forming the end 10 and respectively fastened on the associated handle shell by means of screws 12.

Viewed along the longitudinal extent L of the handle part 5, the respective insert 11 protrudes beyond the contour of the handle part 5 or the handle shells 8 and 9 in the region of the end 10 and forms an engagement structure 13 in this protruding region.

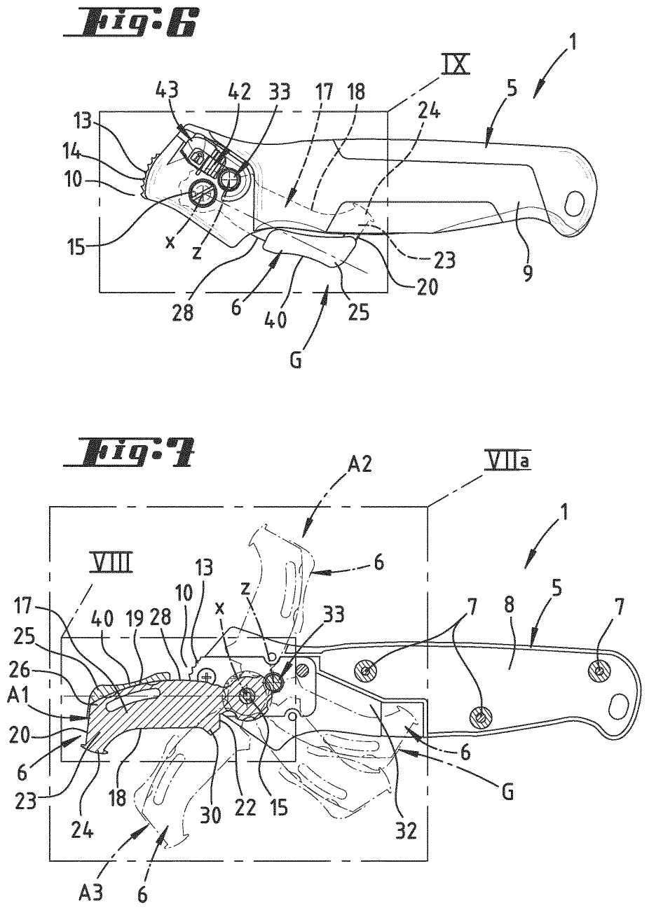

The engagement structure 13 may be formed by a rib structure 14 that extends along an imaginary curved line in a side view, for example, according to FIG. 6, wherein rolling support of the handle part 5, for example on the object 2, can be achieved by means of said rib structure in a predefined operating position of the blade part 6.

The formation of the engagement structure 13 on an insert 11 advantageously makes it possible to offer the engagement structure 13 and the handle part 5 in different materials. For example, the handle shells 8 and 9 may be made, for example, of a hard plastic material whereas the inserts 11 with the engagement structures 13 may be realized, for example, in the form of sheet steel stampings.

The blade part 6 preferably is pivotably captured between the inserts 11, wherein a pivot pin 15 that forms the geometric pivot axis x extends through the blade part 6 in the region of a bore 16 and through the inserts 11 in the region of additional bores 52 in order to achieve this pivotability of the blade part (see FIG. 2).

The blade part 6 initially and essentially has a blade 17 with a longitudinal extent M. A cutting edge 18 and a rear edge 19 lying opposite of this cutting edge essentially extend along this longitudinal extent M. The cutting edge 18 and the rear edge 19 are connected to one another by a leading edge 20 in an end region of the blade 17 that faces away from the handle part 5 or the bore 16 of the blade part 6, respectively.

A bearing lug 21 that also contains the bore 16 may be integrally formed on the blade 17 essentially opposite of the leading edge 20. The rear edge 19 essentially runs into the outer contour of the bearing lug 21 whereas an outer edge 22 that essentially extends transverse to the longitudinal extent L of the blade 10 is formed on the end of the cutting edge 18 such that it faces away from the leading edge 20.

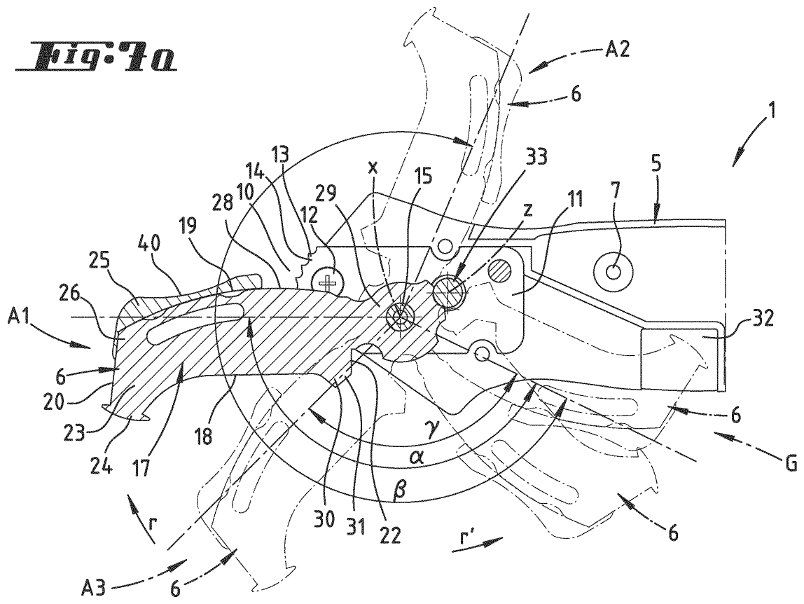

With respect to a section through the blade 17 in the region of the pivoting plane E, e.g. in accordance with the illustrations in FIGS. 7, 7a and 7b, the rear edge 19 extends in a convex manner viewed from the cutting edge 18, wherein it is furthermore preferred that the rear edge 19 is not designed for cutting and therefore preferably realized flatly viewed perpendicular to the pivoting plane E.

The cutting edge 18 that essentially extends linearly over a section, as well as the leading edge 20 that is realized in the form of an additional, essentially linear cutting edge 18′, are realized in a sharp-edged, blade-like manner, wherein a hook-shaped or beak-shaped cutting extension 23, which is exposed relative to the extent of the cutting edge 18, is formed in the transition from the leading edge 20 into the cutting edge 18, and wherein said cutting extension 23 preferably carries a sliding shoe 24 on its end.

The sliding shoe 24 is essentially designed in a disk-like manner and overlaps the facing end sections of the sharp-edged leading edge 20 and the cutting edge 18.

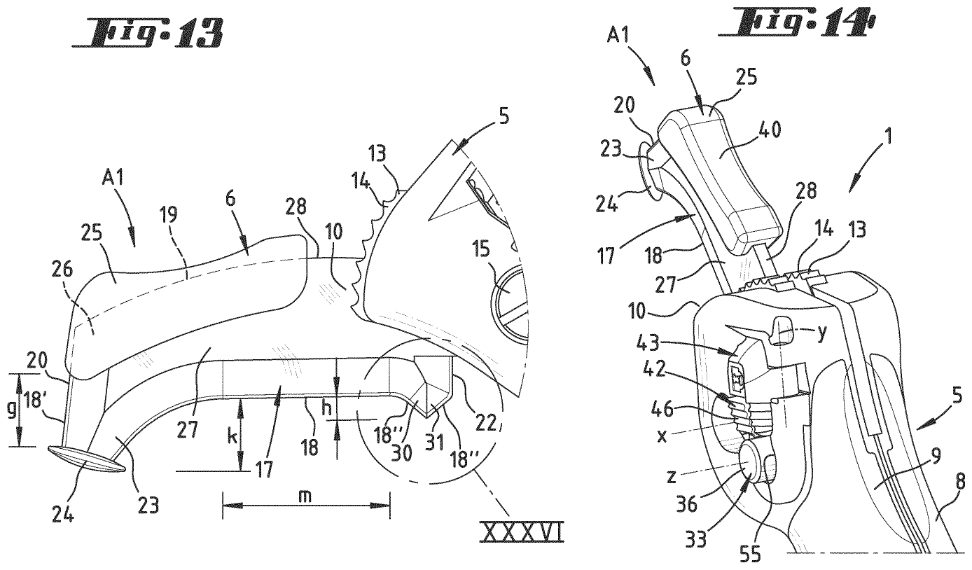

With respect to a side view, for example, according to FIG. 13 or also FIG. 37, a greatest distance k between the linearly extending cutting edge section and the sliding shoe 24 viewed perpendicular to this linearly extending section of the cutting edge 18 may correspond to approximately 0.4-times to 0.7-times the length m of the linearly extending cutting edge section.

Another preferred component of the blade part 6 is a blade protection part 25 that is assigned to the rear edge 19 and supported thereon. This blade protection part preferably is a cap-like hard plastic part that covers the rear edge 19 at least in a section located adjacent to the leading edge 20 or to a transition 26 of the leading edge 20 into the rear edge 19 and furthermore preferably rests against the broad surfaces 27 of the blade on both sides, particularly while keeping the cutting edge 18 exposed (see, for example, FIG. 13 or also FIG. 38).

Furthermore, the blade protection part 25 simultaneously also covers the aforementioned transition 26 and a section of the leading edge 20 located adjacent thereto.

If the leading edge 20 has a length a in a section through the blade 17 in the pivoting plane E, e.g. in accordance with FIG. 7a or 7b, a section of the blade protection part 25 may cover the leading edge 20, starting from the transition 26 of the leading edge 20 into the rear edge 19, over a length b that may correspond to approximately ⅓ to approximately half of the length a of the leading edge. This results in a length g, over which the leading edge 20 or the corresponding cutting edge 18′ is exposed between the blade protection part 25 and the sliding shoe 24 in the sliding direction in order to carry out a cutting process. This length g preferably is adapted to the thickness of a cable sheath and therefore lies, for example, between 3 and 5 mm and optionally may be as large as 6 mm.

With respect to a first operating position of the blade part 6, which is described in greater detail below and illustrated, for example, in FIG. 7, or with respect to a handheld device 1 with a rigid blade part 6 according to FIG. 38, the resulting length c of the rear edge 19, which is covered by the blade protection part 25 starting from the transition 26, corresponds to more than half, e.g. to approximately ⅔ to ⅘, of the length d of the rear edge 19, which freely protrudes beyond the engagement structure 13. Accordingly, a portion 28 of the rear edge 19, which is not covered by the blade protection part 25, is formed between the blade protection part 25 and the optionally provided engagement structure 13 in the first operating position at least in the case of a pivotable blade part 6.

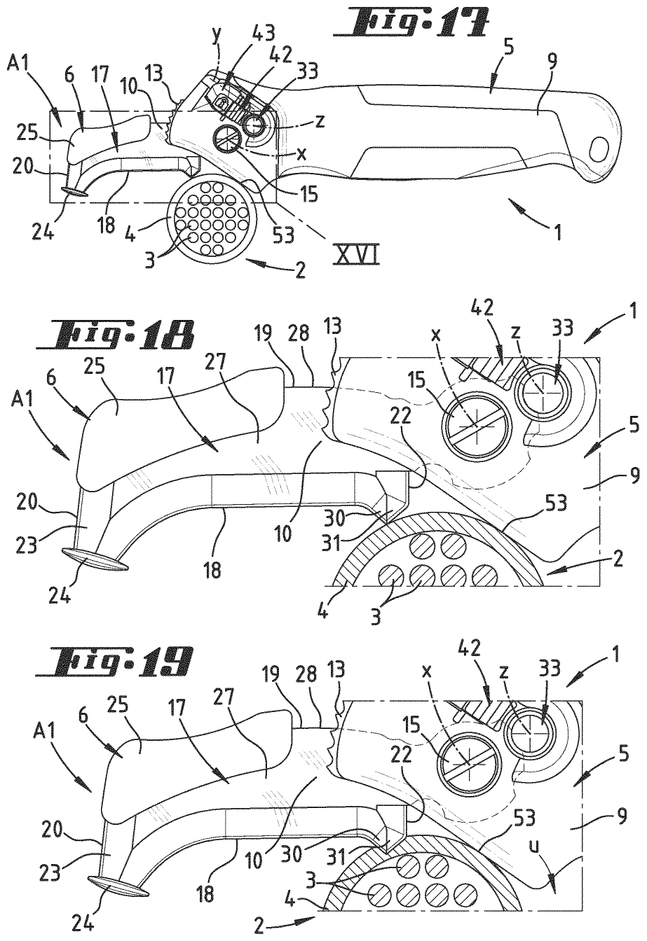

A sharp-edged cutting projection 30 is formed on the end 29 of the blade part 6 facing the handle part 5, particularly in the transition region from the cutting edge 18 into the rear edge 19. According to FIGS. 17 to 19 and 36, for example, this cutting projection may be realized in the form of a spike-like projection 31 that protrudes beyond the cutting edge 18 and has gable roof-like cutting edges 18″.

With respect to a side view, for example, according to FIG. 36, the cutting edges 18″ of the cutting projection 30 may include an angle ε of approximately 80 to 100°, e. g. approximately 90°, with one another, wherein a corresponding angle bisector p furthermore extends, according to a potential embodiment, essentially perpendicular to the linearly extending section of the cutting edge 18 or to an extension of this cutting edge section, respectively (see FIG. 36).

A dimension h, by which the tip 61 of the cutting projection 30 protrudes relative to the linearly extending section of the cutting edge 18, preferably amounts to more than 1.5 mm, e.g. to 2 mm or more, and may, for example, be as large as 5 mm.

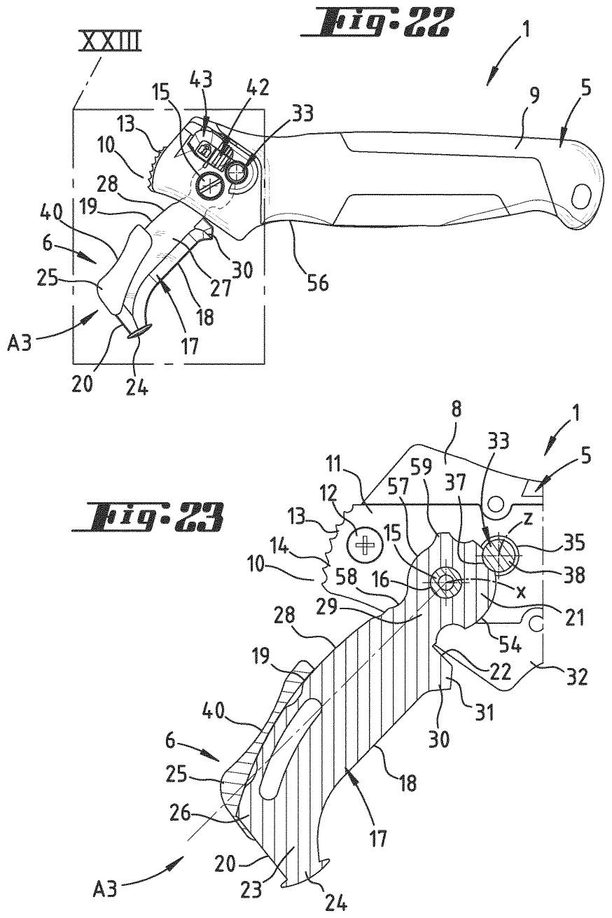

According to the illustration in FIG. 21, the cutting projection 30 may also be formed as a result of a sharp-edged transition, e.g. a right-angled transition, of the cutting edge 18 into the outer edge 22. According to an alternative embodiment illustrated in FIG. 20, the transition forming the cutting projection 30 may also be realized by a rounded cutting edge.

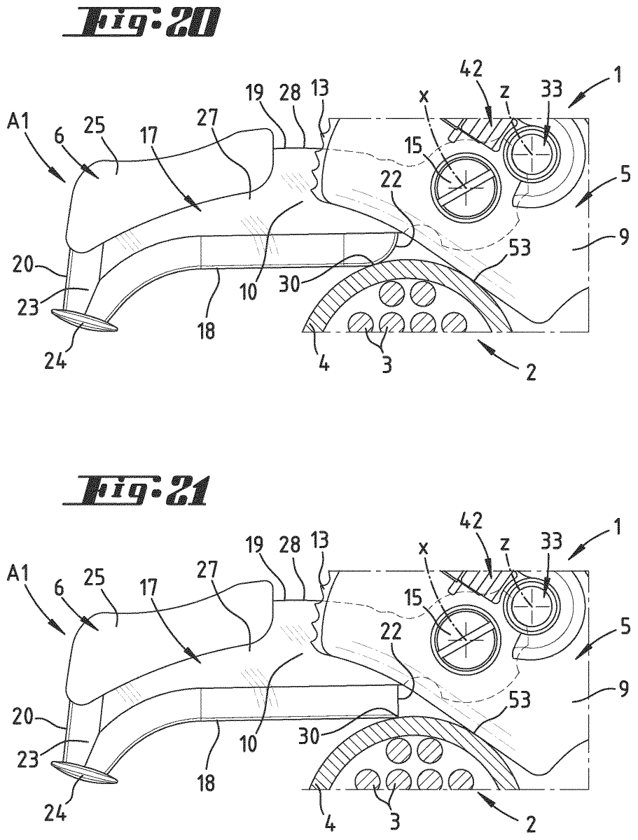

Regardless of the respective design, an exposed cutting projection 30 is formed, by means of which it is possible, for example, to advantageously produce a circumferential cut on an insulating sheath 4, wherein an object to be incised is supported on a contact surface 53 of the handle part 5, which extends at a distance from the cutting projection 30 of the blade 17, when the blade part 6 is aligned in the first operating position. FIG. 19 shows as an example that, as a result of the above-described exposed cutting projection 30, the blade 17 initially digs into the object 2, in this case the insulating sheath 4, when the handheld device 1 as a whole is pivoted in the circumferential direction u of the object 2, and that, for example, a circumferential cut can subsequently be produced with further movement of the handheld device 1 relative to the object 2 in the circumferential direction u.

The pivotability of the blade part 6 relative to the handle part 5 results in different pivoting positions of the blade part 6, preferably in three operating positions and one pivoted-in position.

In the pivoted-in position G illustrated, for example, in FIGS. 3 to 6 and 8, the blade part 6 is accommodated in a slot-shaped receptacle formation 32 of the handle part 5. The receptacle formation 32 essentially is provided on the underside of the handle part 5 during normal handling of the handheld device 1.

The cutting edge 18 and the cutting projection 30 with the outer edge 22, as well as preferably also the sliding shoe 24, completely lie in the receptacle formation 32 in this pivoted-in position G. The blade protection part 25 remains outside the receptacle formation 32 and at least partially covers this receptacle formation in the pivoted-in position G.

Furthermore, a latching between the blade part 6 and the handle part 5 is provided in this pivoted-in position G, as well as in other operating positions. For this purpose, a latching part 33 in the form of a latching pin, which can be displaced perpendicular to the pivoting plane E along a geometric axis z, is provided in the handle part 5 and spring-loaded in the direction of a latching position by means of a spring 34.

The latching part 33 may extend through bores 35 in the inserts 11 as shown and interact with the circumferential edge 54 of the bearing lug 21 on the side of the blade.

The end of the latching part 33 is provided with a pin-like operating handle 37 that extends through the handle part 5 in the region of a bore 55 that freely opens outward, wherein the latching part 33 can be axially displaced along the axis z against the restoring force of the spring 34 by means of said operating handle.

Different latching depressions 37 are formed on the circumference of the blade bearing lug 21 in the edge 54 that furthermore extends essentially concentric to the pivot axis x, wherein an adapted latching section 38 of the latching part 33 engages into said latching depressions in a locking manner in the latching position (see, for example, FIG. 32).

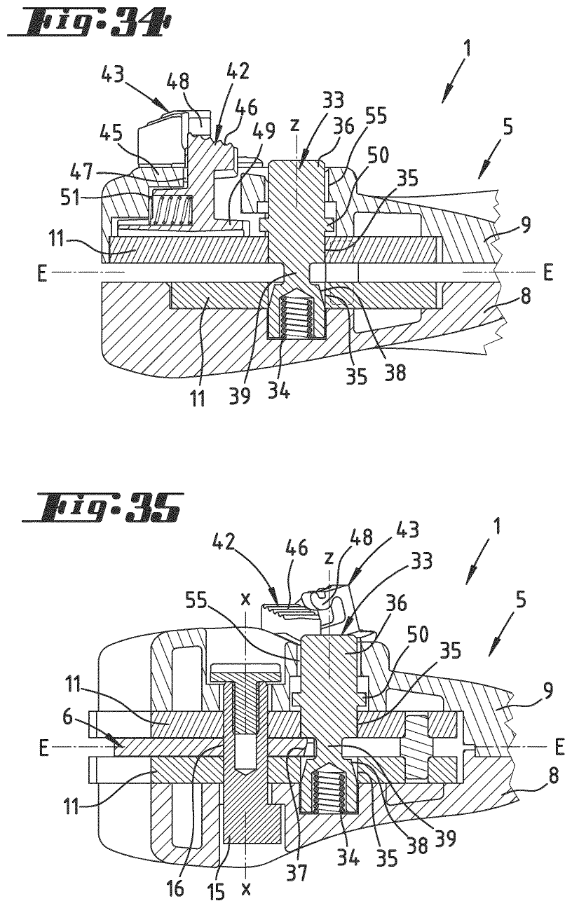

The latching section 38 is moved out of this interacting position with the latching depression 37 of the bearing lug 21 due to an axial displacement of the latching part 33, which is achieved as a result of exerting pressure upon the operating handle 36, wherein a waisted release section 39 with a smaller diameter than the latching section 38 subsequently moves into the interacting region with the respective latching depressions 37 (see, for example, FIG. 35).

A total of three latching positions are provided in the exemplary embodiment shown. This initially concerns the above-described pivoted-in position G, which is assumed as a result of pivoting the blade part 6 in a second pivoting direction r′ from an operating position. Furthermore, two operating positions, namely a first and a third operating position A1 and A3, preferably are latch-secured, wherein the first operating position A1 can be reached, in particular, by pivoting the blade part 6 in a first pivoting direction r starting from the pivoted-in position G. In this context, a first pivoting angle α between the pivoted-in position G and the first operating position A1 may lie between more than 90° and approximately 180°, e. g. between approximately 130 and 150° (see FIG. 7a).

An axial displacement of the latching part 33 along its geometric axis z is initially required in order to be able to pivot the blade part 6, for example, from the pivoted-in position G into the first operating position A1. The subsequently released blade part 6 can now be pivoted. In this case, it is not necessary to axially exert pressure upon the latching part 33 in the course of the pivoting movement because the latching part 33 prevents a backward displacement of the latching part 33 due to the engagement of the circumferential edge 54 of the bearing lug 21 into the waisted release section 39. The latching part 33 is only displaced back into the latching position by the spring 34 once the next latching position in the pivoting direction and therefore the next latching depressions 37 on the bearing lug 21 is reached.

A latch-secured third operating position A3 may be provided between the pivoted-in position G and the first operating position A1, wherein the corresponding third pivoting angle γ between the pivoted-in position G and the third operating position A3 may amount to approximately 80 to 100°, for example to approximately 90°, and therefore to approximately 5/10 to 8/10, for example to approximately 6/10 to 7/10, of the first pivoting angle α (see FIG. 7a).

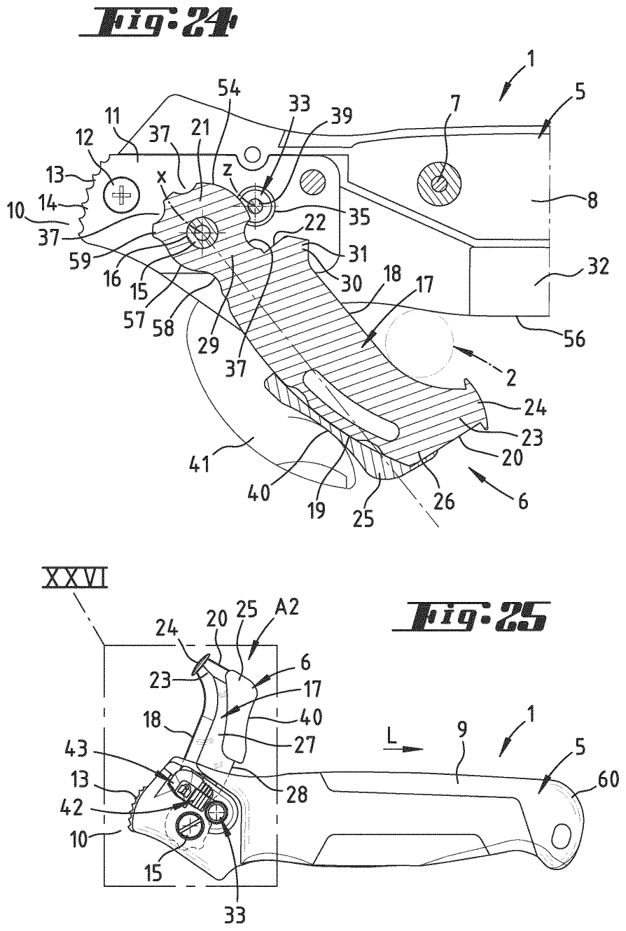

In another embodiment, this third operating position A3 may represent a securing position, which prevents the blade part from pivoting into the receptacle formation 32 and therefore into the pivoted-in position G in the case of an improperly latched first operating position A1 in the course of an unintentional backward pivoting movement of the blade part 6 in the second pivoting direction r′. Accidental pinching of or even injuries to one or more fingers encompassing the handle part 5 in the region of the receptacle formation 32 is therefore prevented. The blade part 6 is latched in the third operating position A3 when it carries out an unintentional backward pivoting movement. The examples illustrated in FIGS. 22 and 23 show that a sufficiently great distance, particularly between the cutting edge 18 of the blade part 6 and the underside 56 of the handle part 5 following in the pivoting direction, is provided in this third operating position A3.

Accordingly, a total of three latch-secured pivoting positions of the blade part 6 are provided in the exemplary embodiment shown, namely the pivoted-in position G, the first operating position A1 and the third operating position A3.

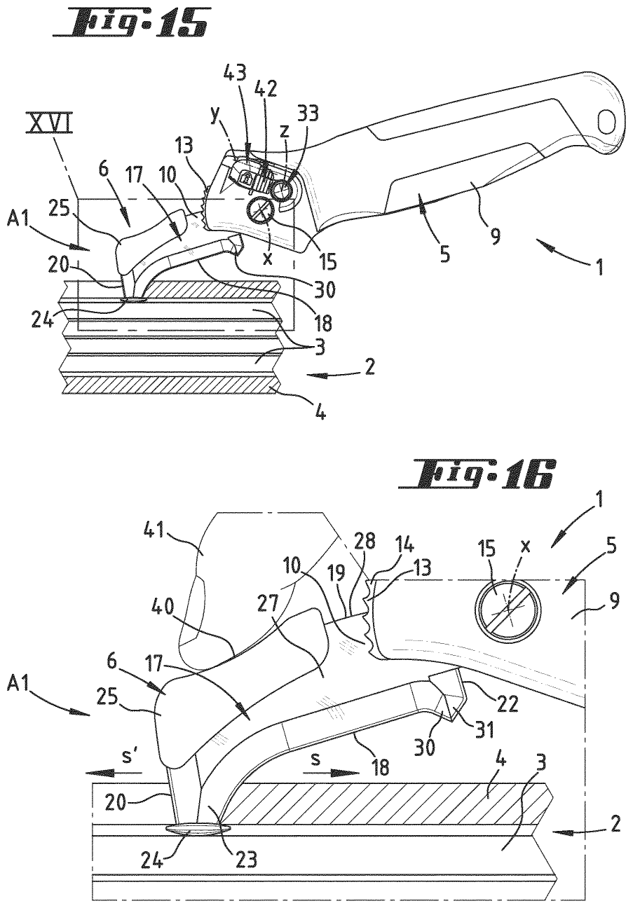

In the above-described first operating position A1, the blade part 6, particularly the blade 17, is normally aligned essentially in extension of the handle part 5, particularly for producing a longitudinal cut in order to cut open, for example, an insulating sheath 4 along its longitudinal extent (see FIGS. 15 and 16). FIG. 7a, for example, shows that the engagement structure 13 preferably can extend beyond the blade 17 or the blade part 6 in the first pivoting direction r and therefore be exposed facing the rear edge 19.

The handheld device 1 can be moved along the object 2 in the direction s in a pulling manner in the first operating position A1, wherein the insulating sheath 4 is severed by the cutting edge 18, particularly in the region of the hook-shaped cutting extension 23, in the exemplary embodiment shown. The sliding shoe 24 extending on the inner side of the insulating sheath 4 prevents damages to the conductors 3 encompassed by the insulating sheath 4.

Alternatively, the handheld device 1 can also be moved in the opposite direction s′ in this first operating position A1 by acting upon the blade part 6 in a pressing manner such that the incision of the object 2 is in this case produced by means of the leading edge 20 (see FIG. 16).

In order to facilitate the cutting process, the user can act upon the blade part 6 in a pressing manner with a finger 41 via the blade protection part 25, wherein the blade protection part 25 may have an adapted depression 40 for this purpose.

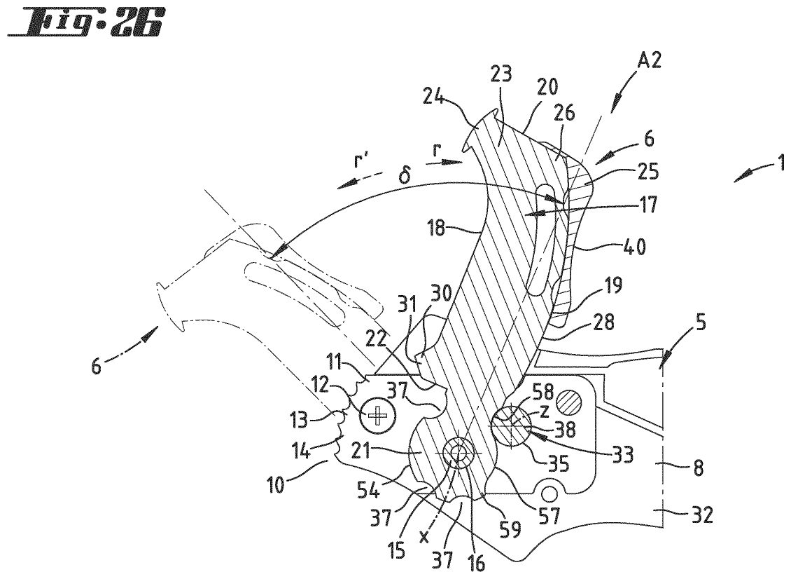

However, the blade part 6 can by all means also be used in pivoting positions that are not latch-secured, e.g. in a pivoting position of the blade part 6 between the third operating position A3 and the pivoted-in position G as illustrated, for example, in FIG. 24. In this position, a circumferential cut can be produced, for example, on objects 2 with small diameters while the object 2 to be cut, e.g. an insulating sheath 4 of an electric cable, is in contact with the underside 56 of the handle part 5 having the opening of the receptacle formation 32, wherein pressure can be exerted upon the blade 17, particularly upon the cutting edge 18, via the blade protection part 25 as described above with reference to the first operating position A1.

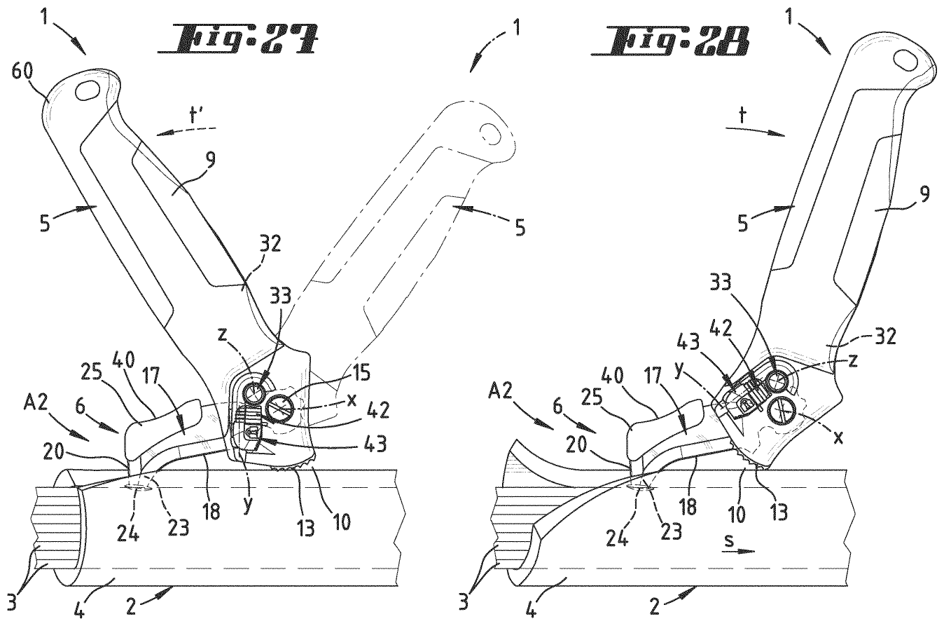

The blade part 6 can also be pivoted beyond the latch-securable first operating position A1 into a second operating position A2 that preferably is not latch-securable (see, for example, FIG. 26). This preferably results in a free pivotability of the blade part 6 between the first operating position A1 and a limit stop that follows in the first pivoting direction r. With respect to the greatest pivoting movement possible, the blade part 6 can, starting from the pivoted-in position G, assume a second pivoting angle β that preferably amounts to more than 180° and may, for example, be as large is 300°, e.g. a pivoting angle between approximately 200 and 270° (see FIG. 7a).

The illustration in FIG. 26, in particular, furthermore shows that the blade part 6 is freely pivotable over a pivoting angle range δ of, for example, approximately 70 to 90° in the second operating position A2. In this case, the latching section 38 of the latching part 33 interacts with an edge section 57 of the bearing lug 21 on the side of the blade part, wherein said edge section 57 essentially extends on a circular arc that is aligned concentric to the pivot axis x and has a radius that essentially corresponds to the radius in the region of the latching depressions 37.

Stops are formed in both pivoting directions r and r′ in this second operating position A2, namely in a transition region 58 between the edge section 57 and the rear edge 19 on the one hand and on a shoulder 59 formed between the edge section 57 and the latching depressions 37 of the bearing lug 21 defining the first operating position A1 on the other hand.

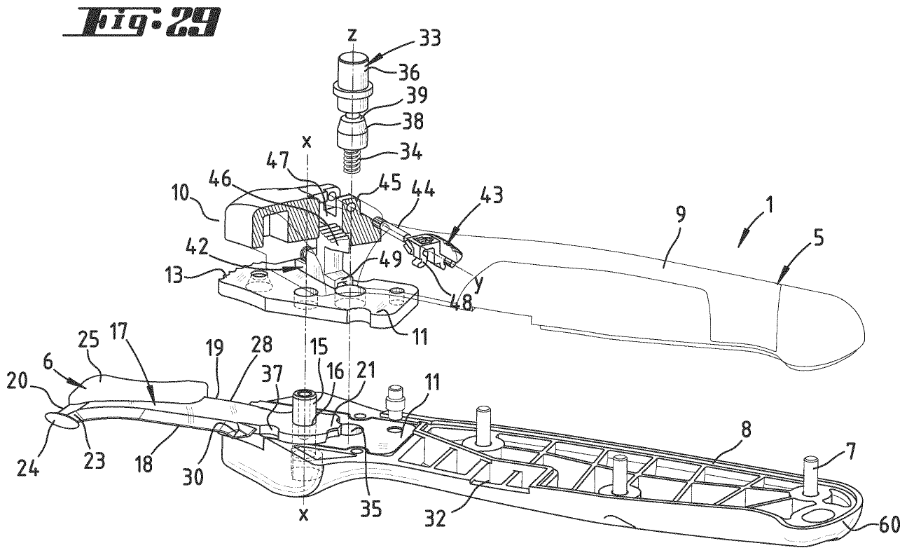

The second operating position preferably is used for producing longitudinal cuts that require a greater expenditure of force. In this case, the handheld device 1 as a whole is used in a ratchet-like manner while the engagement structure 13 of the handle part 5 is supported on the facing surface of the object 2, e.g. the insulating sheath 4 (see FIGS. 27 and 28). The blade part 6 is pulled in the longitudinal direction of the object 2 as described with reference to the first operating position A1, namely as a result of a pivoting movement of the handle part 5 in the pivoting direction t while the engagement structure 13 rolls on the object 2 such that the blade part 6 is subjected to a toggle lever-like pulling effect (see FIG. 28). The next ratchet-like pull of the blade part 6 through the object 2 is initiated by pivoting the handle part 5 back into the starting position according to FIG. 27 in the pivoting direction t′ without further support of the handle part 5, particularly the engagement structure 13, on the object 2.

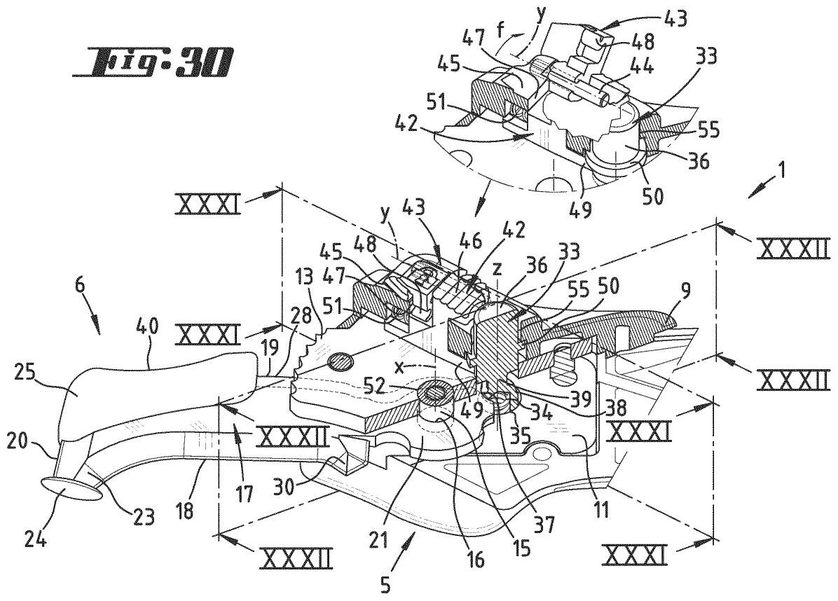

The latching position of the pin-shaped latching part 33 can be blocked by means of a first blocking part 42. This blocking part preferably is a sliding part that can be linearly displaced from a blocking position, which is illustrated as an example in FIG. 30, into a release position in a direction that essentially extends parallel to the alignment of the pivoting plane E. The first blocking part 42 is arranged in the region of the end 10 of the handle part 5 adjacent to the latching part 33 and has an operating handle 46 that extends through a slot-shaped opening 47 of the handle part 5.

The first blocking part 42 is spring-loaded into the blocking position by means of a spring 51, wherein the first blocking part 42 engages underneath a circumferential radial shoulder 50 of the latching part 33 with a locking bar extension 49 in said blocking position and therefore prevents the latching part 33 as a whole from being displaced into a position in which latching is disabled (see FIGS. 30 to 32).

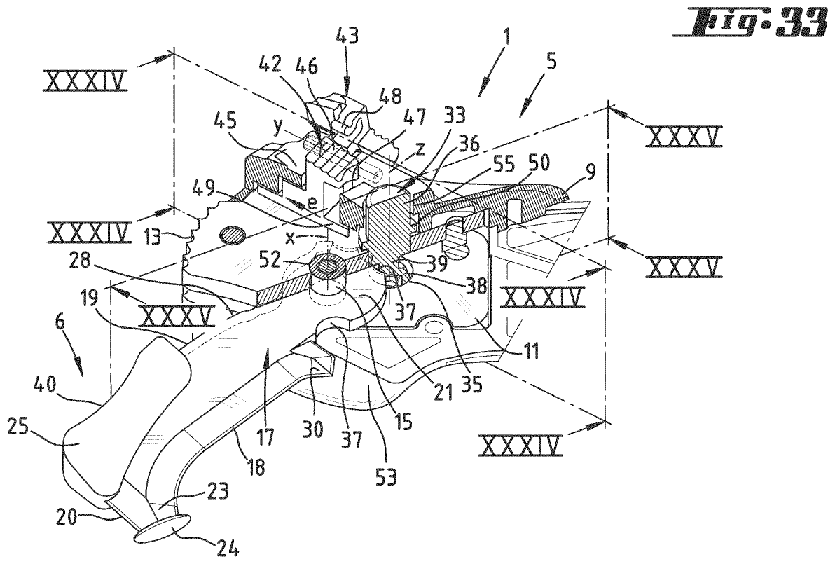

In order to disengage the blocking position, the first blocking part 42 accordingly has to be displaced in the direction of the arrow e, whereupon the locking bar extension 49 releases the radial shoulder 50 and therefore the latching part 33 for its axial displacement (see FIGS. 33 to 35).

FIG. 34 shows the blocking part 42 in the retained release position. After displacing the latching part 33 axially into the latching disengagement position and subsequently releasing the first blocking part 42, the first blocking part is supported on the circumference of the radial shoulder 50 of the latching part 33 by means of the locking bar extension 49.

Once the blade part 6 reaches the next latching position, in which the next latching depression 37 viewed in the pivoting direction interacts with the latching section 38 of the latching part 33, in the course of its pivoting movement about the pivot axis x, the latching part 33 is automatically displaced back into the latching position as a result of the action of the spring 34, wherein the locking bar extension 49 of the first blocking part 42 loses its support on the radial shoulder 50 in the course of this displacement. The blocking part 42 is pushed back into the position, in which it blocks the latching part 33, by means of the spring 51 following the latching part 33.

In another embodiment, the first blocking part 42 can be fixed by means of a second blocking part 43. The second blocking part 43 may be a pivoting part that is retained on the handle part 5 so as to be pivotable about an axle 44 that is mounted in a bearing support 45 of the handle part 5 and forms a geometric pivot axis y. This second blocking part 43 has a locking extension 48 that, in the blocking position, e.g., according to FIG. 30, engages into the region of the opening 47 remaining exposed in the blocking position of the first blocking part 42 rearward of the operating handle 46 of the first blocking part 42 and thereby prevents the first blocking part 42 from carrying out a sliding displacement in the direction of the arrow e. The space for the sliding displacement of the first blocking part 42 is only released once the locking extension 48 is removed from the opening 47 as a result of a pivoting movement of the second blocking part 43 out of this fixing position in the direction of the arrow f (see separate detail in FIG. 30).

The preceding explanations serve for elucidating all inventions that are included in this application and respectively enhance the prior art independently with at least the following combinations of characteristics, wherein two, multiple or all of these combinations of characteristics may also be combined with one another, namely:

A handheld device, which is characterized in that the blade 17 can be latched in the first operating position A1, which corresponds to a first pivoting angle α, and in that, once the latching has been disabled, free pivotability between the blade part 6 and the handle part 5 is made possible in a pivoting angle range δ exceeding the first pivoting angle α in order to make use of the engagement structure 13.

A handheld device, which is characterized in that the engagement structure 13 is a rib structure 14.

A handheld device, which is characterized in that the engagement structure 13 extends beyond the blade 17 in the first pivoting direction r in the first operating position A1.

A handheld device, which is characterized in that the blade part 6 can be pivoted into a third operating position A3 that corresponds to a third pivoting angle γ, and in that the blade part 6 can be latched in the third operating position A3.

A handheld device, which is characterized in that the third pivoting angle γ corresponds to one-tenth to nine-tenths of the first pivoting angle α.

A handheld device, which is characterized in that the pivoted-in position G can be latched.

A handheld device, which is characterized in that the latching can be produced between a handle part end 29 of the blade part 6 assigned to the handle part 5 and a latching part 33 provided in the handle part 5.

A handheld device, which is characterized in that the latching part is movable perpendicular to the pivoting plane E.

A handheld device, which is characterized in that the latching part 33 can be blocked in a latching position by means of a first blocking part 42.

A handheld device, which is characterized in that the first blocking part 42 is a sliding part that can be moved between a release position and a blocking position in a plane lying parallel to the pivoting plane E.

A handheld device, which is characterized in that the sliding part can be fixed in its blocking position by means of a second blocking part 43.

A handheld device, which is characterized in that the second blocking part 43 is a flap part that is movable about a second pivot axis y.

A handheld device, which is characterized in that the handle part end 29 of the blade part 6 is accommodated in the handle part 5.

A handheld device, which is characterized in that the blade 17 has a cutting edge 18 and a rear edge 19.

A handheld device, which is characterized in that the blade 17 has a second free end, which is located distant from the handle part end 29 in a direction of the longitudinal extent M and has a leading edge 20.

A handheld device, which is characterized in that the cutting edge 18 has a cutting projection 30 that protrudes relative to the remaining section of the cutting edge 18 extending along the longitudinal extent M of the blade part 6, and in that the cutting projection 30 is formed on the end 29 of the blade 17 facing the handle part 5.

A handheld device, which is characterized in that the cutting projection 30 protrudes relative to the section of the cutting edge 18 located directly adjacent thereto along the longitudinal extent M by a dimension h that amounts to 1.5 mm or more.

A handheld device, which is characterized in that, in a view in which the cutting edge 18 is illustrated in the form of a line, the cutting projection 18 is realized in a pointed manner similar to a gable roof, wherein the edges of the projection that meet in the tip 61 are realized in the form of cutting edges 18″.

A handheld device, which is characterized in that the cutting projection 30 protrudes relative to the remainder of the cutting edge 18 in the second pivoting direction r′.

A handheld device, which is characterized in that a part of the blade 17, which comprises the cutting edge 18 with the cutting projection 30, is accommodated in a receptacle formation 32 of the handle part 5 in the pivoted-in position G.

A handheld device, which is characterized in that the blade 17 has a sliding shoe 24.

A handheld device, which is characterized in that the blade 17 has a blade protection part 25 that is assigned to the rear edge 19.

A handheld device, which is characterized in that the blade protection part 25 remains outside the receptacle formation 32 in the pivoted-in position G.

A handheld device, which is characterized in that the cutting edge 18 is exposed when the blade protection part 25 is supported on the rear edge 19 of the blade 17, and in that the blade protection part 25 not only covers part of the rear edge 19, but also part of the leading edge 20, as well as a transition 26 of the leading edge 20 into the rear edge 19.

A handheld device, which is characterized in that the blade protection part 25 has a depression 40 in the direction of the longitudinal extent M in order to accommodate a supporting finger 41 of a user.

A handheld device, which is characterized in that a portion of the rear edge 19 is exposed between the handle part 5 and the blade protection part 25.

A handheld device, which is characterized in that the leading edge 20 is realized in the form of a cutting edge 18′.

A handheld device, which is characterized in that the region of the leading edge 20, which is exposed beyond the blade protection part 25, has a length g of less than 10 mm.

All disclosed characteristics are essential to the invention (individually, but also in combination with one another). The disclosure of the associated/attached priority documents (copy of the priority application) is hereby fully incorporated into the disclosure content of this application, namely also for the purpose of integrating characteristics of these documents into claims of the present application. The characteristics of the dependent claims also characterize independent inventive enhancements of the prior art without the characteristics of a claim to which they refer, particularly for submitting divisional applications on the basis of these claims. The invention specified in each claim may additionally comprise one or more of the characteristics that were disclosed in the preceding description and, in particular, are identified by reference symbols and/or included in the list of reference symbols. The invention also concerns design variations, in which individual characteristics cited in the preceding description are not realized, particularly as far as they are obviously dispensable for the respective intended use or can be replaced with other, identically acting technical means.

### LIST OF REFERENCE SYMBOLS

1 Handheld device
2 Object
3 Conductors
4 Insulating sheath
5 Handle part
6 Blade part
7 Screw
8 Handle shell
9 Handle shell
10 Second end
11 Insert
12 Screw
13 Engagement structure
14 Rib structure
15 Pivot pin
16 Bore
17 Blade
18 Cutting edge
18′ Cutting edge
18″ Cutting edge
19 Rear edge
20 Leading edge
21 Bearing lug
22 Outer edge
23 Cutting extension
24 Sliding shoe
25 Blade protection part
26 Transition
27 Broad surface of blade
28 Portion
29 End
30 Cutting projection
31 Projection
32 Receptacle formation
33 Latching part
34 Spring
35 Bore
36 Operating handle
37 Latching depression
38 Latching section
39 Release section
40 Depression
41 Finger
42 First blocking part
43 Second blocking part
44 Axle
45 Bearing support
46 Operating handle
47 Opening
48 Locking extension
49 Locking bar extension
50 Radial shoulder
51 Spring
52 Bore
53 Contact surface
54 Edge
55 Bore
56 Underside
57 Edge section
58 Transition region
59 Shoulder
60 First end
61 Tip
a Length
b Length
c Length
d Length
e Direction
f Direction
r First pivoting direction
r′ Second pivoting direction
s Direction
s′ Direction
t Pivoting direction
t′ Pivoting direction
u Circumferential direction
x Pivot axis
y Pivot axis
z Axis
A1 First operating position
A2 Second operating position
A3 Third operating position
E Pivoting plane
G Pivoted-in position
L Longitudinal direction
M Longitudinal direction
g Length
h Protruding dimension
k Distance
m Length
p Angle bisector
α Pivoting angle
β Pivoting angle
γ Pivoting angle
δ Pivoting angle range
ε Angle

1. A handheld device (1) comprising: a blade (17), a handle part (5) with a longitudinal extent (L), a first end (60) and a second end (10) and a blade part (6) with the blade (17), wherein the blade part (6) is assigned to the second end (10) and is mounted on the handle part (5) such that the blade part is pivotable about a first pivot axis (x) in a pivoting plane (E) extending in a direction of the longitudinal extent (L) in order to move the blade (17) in a first pivoting direction (r) out of a pivoted-in position (G), in which the second end (10) delimits the handheld device (1) along the longitudinal extent (L), into a first operating position (A1), in which the blade (17) protrudes beyond the second end (10) along the longitudinal extent (L), and wherein the blade part (6) is configured to be moved back into the pivoted-in position (G) in a second pivoting direction (r′) and the handle part (5) has on the second end (10) an engagement structure (13) for rolling support on an object (2) to be cut, wherein the blade (17) is configured to be latched in the first operating position (A1), which corresponds to a first pivoting angle (α), and wherein, once the latching has been disabled, free pivotability between the blade part (6) and the handle part (5) is made possible in a pivoting angle range (δ) exceeding the first pivoting angle (α) in order to make use of the engagement structure (13).

2. The handheld device according to claim 1, wherein the engagement structure (13) is a rib structure (14).

3. The handheld device according to claim 1, wherein the engagement structure (13) extends beyond the blade (17) in the first pivoting direction (r) in the first operating position (A1).

4. The handheld device according to claim 1, wherein the blade part (6) is configured to be pivoted into a third operating position (A3) that corresponds to a third pivoting angle (γ), and wherein the blade part (6) is configured to be latched in the third operating position (A3).

5. The handheld device according to claim 4, wherein the third pivoting angle (γ) corresponds to one-tenth to nine-tenths of the first pivoting angle (α).

6. The handheld device according to claim 1, wherein the pivoted-in position (G) can be latched.

7-13. (canceled)

14. The handheld device according to claim 1, wherein the blade (17) has a cutting edge (18) and a rear edge (19).

15. The handheld device according to claim 7, wherein the blade (17) has a second free end, which is located distant from the handle part end (29) in a direction of the longitudinal extent (M) and has a leading edge (20).

16. A handheld device (1) comprising a blade (17), wherein the handheld device (1) has a handle part (5) and a blade part (6) with the blade (17), wherein the blade part (6) has a longitudinal extent (M) and is fastened on the handle part (5) on a first end (29), wherein another, second free end of the blade part (6), which is located distant from the first end (29) in a direction of the longitudinal extent (M), has a leading edge (20), wherein the blade (17) has a cutting edge (18), and wherein the leading edge (20), as well as the cutting edge (18), ends in a sliding shoe (24) that protrudes beyond a section of the cutting edge (18) extending along the longitudinal extent (M) of the blade part (6), wherein the cutting edge (18) has a cutting projection (30) that protrudes relative to the remaining section of the cutting edge (18) extending along the longitudinal extent (M) of the blade part (6), and wherein the cutting projection (30) is formed on the end (29) of the blade (17) facing the handle part (5).

17. The handheld device according to claim 16, wherein the cutting projection (30) protrudes relative to a section of the cutting edge (18) located directly adjacent thereto along the longitudinal extent (M) by a dimension (h) that amounts to 1.5 mm or more.

18. The handheld device according to claim 16, wherein, in a view in which the cutting edge (18) is illustrated in the form of a line, the cutting projection (30) is pointed similar to a gable roof, wherein edges of the projection that meet in the tip (61) are in the form of cutting edges (18″).

19. The handheld device according to claim 16, wherein the blade part is pivotable about a first pivot axis (x) in a pivoting plane (E) extending in a direction of the longitudinal extent (L) of the handle part in order to move the blade (17) in a first pivoting direction (r) out of a pivoted-in position (G), in which the second end (10) delimits the handheld device (1) along the longitudinal extent (L) of the handle part, into a first operating position (A1), in which the blade (17) protrudes beyond the second end (10) along the longitudinal extent (L) of the handle part, wherein the blade part (6) is configured to be moved back into the pivoted-in position (G) in a second pivoting direction (r′) and wherein the cutting projection (30) protrudes relative to the remainder of the cutting edge (18) in the second pivoting direction (r′).

20. The handheld device according to claim 16, wherein the blade part (6) is movable between a pivoted-in position and an operating position.

21. The handheld device according to claim 20, wherein a part of the blade (17), which comprises the cutting edge (18) with the cutting projection (30), is accommodated in a receptacle formation (32) of the handle part (5) in the pivoted-in position (G).

22. The handheld device according to claim 1, wherein the blade (17) has a sliding shoe (24).

23. The handheld device according to claim 14, wherein the blade (17) has a blade protection part (25) that is assigned to the rear edge (19).

24. (canceled)

25. A handheld device (1) comprising a blade (17), wherein the handheld device (1) has a handle part (5) and a blade part (6) with the blade (17), wherein the blade part (6) has a longitudinal extent (M) and is fastened on the handle part (5) on a first end (29), wherein another, second free end of the blade part (6), which is located distant from the first end (29) in the direction of the longitudinal extent (M), has a leading edge (20), and wherein the blade (17) has a cutting edge (18) and the blade part (6) has a blade protection part (25) that covers a rear edge (19) of the blade (17) facing away from the cutting edge (18), wherein the cutting edge (18) is exposed when the blade protection part (25) is supported on the rear edge (19) of the blade (17), and wherein the blade protection part (25) covers part of the rear edge (19), part of the leading edge (20), and a transition (26) of the leading edge (20) into the rear edge (19).

26. The handheld device according to claim 25, wherein the blade protection part (25) has a depression (40) in the direction of the longitudinal extent (M) in order to accommodate a supporting finger (41) of a user.

27. The handheld device according to claim 25, wherein a portion of the rear edge (19) is exposed between the handle part (5) and the blade protection part (25).

28. The handheld device according to claim 25, wherein the leading edge (20) is a cutting edge (18′).

29. (canceled)
